(19) United States
(12) Patent Application Publication
(10) Pub. No.: US 2018/0091526 A1
(43) Pub. Date: Mar. 29, 2018

(54) MITIGATING AN INTERNET OF THINGS (IoT) WORM

(71) Applicant: QUALCOMM Incorporated, San Diego, CA (US)

(72) Inventors: Rosario Cammarota, San Diego, CA (US); Peerapol Tinnakornsrisuphap, San Diego, CA (US)

(21) Appl. No.: 15/274,457

(22) Filed: Sep. 23, 2016

(51) Int. Cl. H04L 29/06

(52) U.S. Cl. CPC H04L 63/145; H04L 63/1425; H04L 63/1416

(57) ABSTRACT

This disclosure provides systems, methods and apparatus, including computer programs encoded on computer storage media for mitigating an Internet of things (IoT) worm. In one aspect, a processor of a router device may randomly select a plurality of Internet Protocol (IP) addresses. The processor may expose one or more emulated services at the plurality of randomly selected IP addresses. The processor may determine whether IoT worm communication activity is detected at one of the randomly selected IP addresses. The processor may grant to, or otherwise enable, an IoT worm access to one of the emulated services in response to detecting IoT worm communication activity at one of the selected IP addresses.

### TECHNICAL FIELD

This disclosure relates to mitigating an Internet of Things (IoT) worm, and more specifically, to detecting and proactively addressing the IoT worm.

### DESCRIPTION OF THE RELATED TECHNOLOGY

Computing devices that include wireless communication capabilities are becoming smaller, cheaper, and increasingly ubiquitous. Such computing devices are being incorporated with more and more objects, gradually creating a massively distributed network of computing devices generally referred to as the Internet of Things (IoT). Common residential and commercial computer networks served by a local access point (such as a Wi-Fi access point) are increasingly populated by IoT devices.

Malicious software attacks on networks that use IoT devices as the vector for introducing the malicious software to the network are becoming a major concern. Such so-called “IoT worms” share certain common behaviors. For example, an IoT worm may perform a scan to find an open socket on an access point of the network, and then attempt to determine a password to access the network. Once network access is gained, the malicious software injects a malicious payload of software into the access point to perform an action on the network, and further distributes the malicious software or payload.

### SUMMARY

The systems, methods and devices of this disclosure each have several innovative aspects, no single one of which is solely responsible for the desirable attributes disclosed herein.

One innovative aspect of the subject matter described in this disclosure may be implemented in a method of mitigating an Internet of Things (IoT) worm. In some implementations, the method may include randomly selecting, by a router device, a plurality of Internet Protocol (IP) addresses, exposing at the plurality of randomly selected IP addresses one or more emulated services, determining whether IoT worm activity is detected at one of the selected IP addresses, and enabling an IoT worm access to one of the emulated services in response to detecting IoT worm communication activity at one of the selected IP addresses in response to detecting the IoT worm communication activity at the one of the selected IP addresses.

Some implementations may further include binding the randomly selected plurality of IP addresses to the one or more emulated services. In some implementations, detecting the IoT worm communication at the one of the selected IP addresses may be based on a communication pattern of the IoT worm. Some implementations may further include redirecting a communication of the IoT worm to another IP address of the router device. Some implementations may further include monitoring communication activity at the randomly selected IP addresses, and determining whether the IoT worm communication activity is detected at one or more of the randomly selected IP addresses.

Some implementations may further include changing a binding of an IP address other than the plurality of randomly selected IP addresses in response to determining that IoT worm communication activity is detected at the other IP address. Such implementations may further include determining whether to change one or more of the randomly selected IP addresses and the emulated services in response to determining that IoT worm communication activity is not detected at the other IP address.

In some implementations, enabling the IoT worm access to one of the emulated services may include denying access to the one of the emulated services a number of times before enabling access to one of the emulated services. Some implementations may further include sending a message to one or more of a device manager of the router device and a device of a manufacturer of the router device to flag the presence of the IoT worm.

Further implementations may include a router device including a communication interface, and a processor coupled to the communication interface and configured with processor-executable instructions to perform operations of the implementation methods summarized above. Further implementations may include a non-transitory processor-readable storage medium having stored thereon processor-executable software instructions configured to cause a processor to perform operations of the implementation methods summarized above. Further implementations may include a multimode communication device that includes means for performing functions of the implementation methods summarized above.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a system block diagram of a communication environment.

FIG. 2 is a component block diagram illustrating a router device suitable for use with various implementations.

FIGS. 3A and 3B are process flow diagrams illustrating methods for mitigating an IoT worm.

FIG. 4 is a state diagram illustrating methods of mitigating an IoT worm.

FIG. 5 is a component block diagram illustrating an IoT device suitable for use in various implementations.

Like reference numbers and designations in the various drawings indicate like elements.

### DETAILED DESCRIPTION

Various implementations provide methods for mitigating an Internet of Things (IoT) worm. In some implementations, a router device or similar device may be configured to detect an attempted IoT worm attack and to proactively address the IoT worm to protect an IoT network.

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving RF signals according to any of the Institute of Electrical and Electronics Engineers (IEEE)16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as an IEEE 802.15.4 protocol (for example, Thread, ZigBee, and Z-Wave), 6LoWPAN, Bluetooth Low Energy (BLE), LTE Machine-Type Communication (LTE MTC), Narrow Band LTE (NB-LTE), Cellular IoT (CIoT), Narrow Band IoT (NB-IoT), BT Smart, Wi-Fi, LTE-U, LTE-Direct, MuLTEfire, as well as relatively extended-range wide area physical layer interfaces (PHYs) such as Random Phase Multiple Access (RPMA), Ultra Narrow Band (UNB), Low Power Long Range (LoRa), Low Power Long Range Wide Area Network (LoRaWAN), Weightless, or a system utilizing 3G, 4G or 5G, or further implementations thereof, technology.

The term “IoT device” is used herein generally to refer to any of a variety of devices including a processor and transceiver for communicating with other devices or a network. For ease of description, examples of IoT devices are described as communicating via radio frequency (RF) wireless communication links, but IoT devices may communicate via wired or wireless communication links with another device (or user), for example, as a participant in a communication network, such as the IoT. Such communications may include communications with another wireless device, a base station (including a cellular communication network base station and an IoT base station), an access point (including an IoT access point), or other wireless devices.

The term “router device” is used herein to refer to a device that may be included as a network element in a communication network to determine a network path or location to send data over the communication network. The router device may determine a binding between an Internet Protocol (IP) address and a device or service on the network. The router device may be included in a gateway between two or more communication networks, such as a local IoT network and the Internet.

A router device may be configured to communicate with a wide array of IoT devices, including any one or all of cellular telephones, smart phones, personal or mobile multi-media players, personal data assistants (PDAs), laptop computers, tablet computers, smart books, palmtop computers, gaming systems and controllers, smart appliances including televisions, set top boxes, kitchen appliances, lights and lighting systems, smart electricity meters, heating, ventilation, and air conditioning (HVAC) systems, thermostats, building security systems including door and window locks, vehicular entertainment systems, vehicular diagnostic and monitoring systems, unmanned or semi-autonomous aerial vehicles, automobiles, sensors, machine-to-machine devices, and similar devices that include a programmable processor and memory and circuitry for establishing wireless communication pathways and transmitting/receiving data via wireless communication pathways.

Malicious software attacks on networks may attempt to use IoT devices as a vector for introducing the malicious software into the network. For example, malicious software may be introduced onto IoT device, such as at a point of manufacture or distribution or during use, and the malicious software may then attempt to infiltrate a network from within (such as from inside a firewall of a router device, or from within a network in communication with an internal communication interface of a router device).

Such so-called IoT worms (such as Linux/Moose, Remaiten, Linux.Darlloz, etc.) share certain common behaviors, which may be detected by a network element such as a router device. For example, an IoT worm may perform a scan to detect characteristics of a potential target network, service, or device, such as to determine a list of open ports, an operating system version, software version(s), protocols implemented, and the like, and may form a “fingerprint” describing the detected characteristics. The IoT worm may then initiate one or more attacks that may apply to the “fingerprint” in an attempt to gain access to the target network, service, or device. For example, the IoT worm may attempt to access an open socket or access point. As another example, the IoT worm may attempt to determine a password to access the network, such as through a “dictionary attack” in which typical passwords (such as “password,” “1234,” and default passwords of various components and networks) are used in a sequence of access attempts. As another example, the IoT worm may attempt a buffer overflow or a similar attack to bypass access control mechanisms to gain access to a network, service, or device. As another example, the IoT worm may attempt a denial of service attack in order to, for example, overwhelm a defense function, to expose vulnerabilities, or as a decoy to distract a defense function. As yet another example, the IoT worm may use a man-in-the-middle attack during a system update (such as of a network, a service, or a device) in which the IoT worm fakes a source of a software update and uploads malicious software on the target. A router device may be configured to detect these and other such attack behaviors, and to identify them as communication activity of an IoT worm.

In the event that the attack is not detected, the malicious software may gain access to the network. Once network access is gained, the IoT worm injects a malicious payload of software into the access point, which causes the access point to perform an action on the network, and to further distribute the malicious software or payload. For example, malicious software may attempt to connect to a command and control server, and then attempt to execute one or more commands from the command and control server, such as downloading another section of the IoT worm, performing a malicious activity (for example, sending email spam, performing a file transfer, bitcoin mining, etc.), as well as attempting to propagate the IoT worm.

Current mitigation techniques to protect home networks from attack are too technical for most users. While IoT device vendors may provide incident response, such as patches, the slowness of developing and distributing such responses leaves systems vulnerable for long periods of time after an IoT worm is discovered. Further, intrusion detection systems require training and tuning, in addition to generally being relatively slow to respond.

Various implementations provide methods, router devices configured to perform the methods, and non-transitory media storing software implementing the methods, of detecting an IoT worm in an IoT network. In various implementations, a router device may present or expose to the network an IP address of an isolation and mitigation unit that is configured to attract, detect, isolate, or respond to an IoT worm. In some implementations, the isolation and mitigation unit is implemented within a router device (such as a network access point). This is in contrast to conventional network honeypot systems that are typically deployed in a dedicated server or another computing device. In some implementations, the router device may include an internal communication interface and an external communication interface, enabling the isolation and mitigation unit to detect IoT worm communication activity at either or both of the internal and external communication interfaces. The router device typically has access to or control over the assignment of IP addresses and data routing within its network, and thus may be configured to control communication between an IoT worm, potential targets of the IoT worm, and the isolation and mitigation unit. In some implementations, the router device may dynamically control and change IP address assignments for the potential targets of the IoT worm as well as the isolation and mitigation unit.

In some implementations, the router device may allocate a pool of randomly selected IP addresses to the isolation and mitigation unit. In some implementations, the router device may select random IP addresses within a range of IP addresses. In some implementations, the router device may randomly select the range of IP addresses. The router device may bind the randomly selected IP addresses to one or more ports (a logical network endpoint).

The router device may expose an emulated service (i.e., a service or device that is not actually available) at one or more of the randomly selected IP addresses. For example, an emulated service may have a name, or may provide responses and other behaviors, that emulate or replicate one or more vulnerabilities of an IoT device, or a network service or vulnerability that an IoT worm may attempt to exploit. Examples of vulnerabilities of an IoT device or a network service include a weakness in login credentials, a weakness in an authentication or authorization mechanism, an insecure web, mobile, or cloud device interface, and insecure software or firmware.

In some implementations, the router device may detect an attempted attack by an IoT worm by detecting, for example, a scan of a range of IP addresses (such as a telnet scan), multiple attempts to login to an exposed service or device (such as a dictionary attack or other similar multiple login attempts), and the like. In some implementations, the router device may detect a scan of one or more open sockets on an access point of the network. In some implementations, the router device may detect an attempt to determine a password to access the network (for example, a dictionary attack used in a sequence of access attempts).

The emulated service may be configured to provide an IoT worm various responses and behaviors simulating to the IoT worm a successful attack. In some implementations, the router device may configure an emulated service as a remote-shell-like service. In some implementations, the router device may simulate security measures of the network, such as denying access to the network for a number of access attempts with various passwords before finally granting or otherwise enabling the IoT worm access to the emulated service. In some implementations, the router device may select a random number of login attempts that will be denied before the router device permits a detected IoT worm to login to the emulated service. Simulating security measures in this manner may defeat algorithms implemented within the IoT worm to detect isolation and mitigation units by recognizing when network access with relative ease.

In some implementations, the router device may monitor communication activity at the one or more ports or randomly selected IP addresses. In some implementations, the router device may determine that certain communication activity meets a threshold level of communication activity. For example, the router device may determine that a connection attempt has been made at a threshold number of the randomly selected IP addresses. As another example, the router device may determine that a threshold number of attempts have been made at one or more of the randomly selected IP addresses. In some implementations, the threshold number may include average number of login attempts. In some implementations, the router device may determine that a threshold number of the detected connection attempts originated from the same (or substantially the same) source (such as by reviewing on one or more IP addresses of the source or another indicator of network location or identity of the source).

The router device may monitor activity of an IoT worm to detect, for example, an attempt to establish communication (such as telnet) with an external IoT worm command and control server, an attempt to download additional software (such as a malicious payload), or other IoT worm activity. The router device may permit the IoT worm to download a malicious payload, and may permit the execution of the malicious payload in a virtual sandbox environment (such as an isolated virtual machine). In some implementations, the router device may route outgoing traffic from the IoT worm (such as command and control traffic) to one or more IP addresses of the router device, thereby routing the outgoing traffic from the IoT worm to a loopback within the router device, to isolate the IoT worm within the router device.

In some implementations, the router device may flag the presence of the IoT worm (such as by storing an indication of the IoT worm in memory) or may report the presence of the IoT worm to a user, IT support, a security team, law enforcement, or other such parties. In some implementations, the router device may record external communication attempts by the IoT worm, including network addresses used by the IoT worm, as well as other information related to the external communication attempts (such as a source address, a rate of attempted connections, a requested domain name service (DNS), etc.). In some implementations, the router device may communicate the recorded information to an analytical engine for modeling, analysis, and extrapolation of attack patterns.

In various implementations, the router device may perform one or more actions to mitigate or isolate IoT devices on the IoT network to protect the IoT devices from the IoT worm. In particular, the router device may detect whether an IoT device on the IoT network is utilizing an IP address that is within the range of randomly selected IP addresses, or that is within a range of IP addresses over which the router device has detected scanning by an IoT worm.

In some implementations, the router device may periodically change the randomly selected IP addresses or the emulated services exposed, to increase the likelihood of detecting an IoT worm.

Implementing the isolation and mitigation unit in the router device improves the functioning of the computer network, and improves the functioning of an IoT network in particular. The router device has access to and control over the assignment and binding of IP addresses, and further, the router device is always part of a signal path between an IoT worm and a potential target (such as an IoT device on the IoT network). Implementing the isolation and mitigation unit in the router device improves the timing, speed, and accuracy of detecting an IoT worm on a network, and in particular provides earlier detection of an IoT worm than detection systems deployed in a dedicated server. Further, implementing the isolation and mitigation unit in the router device enables the router to stop the propagation of an IoT worm early in its penetration into a network, as well as preventing or containing an infection by the IoT worm of IoT devices in the network.

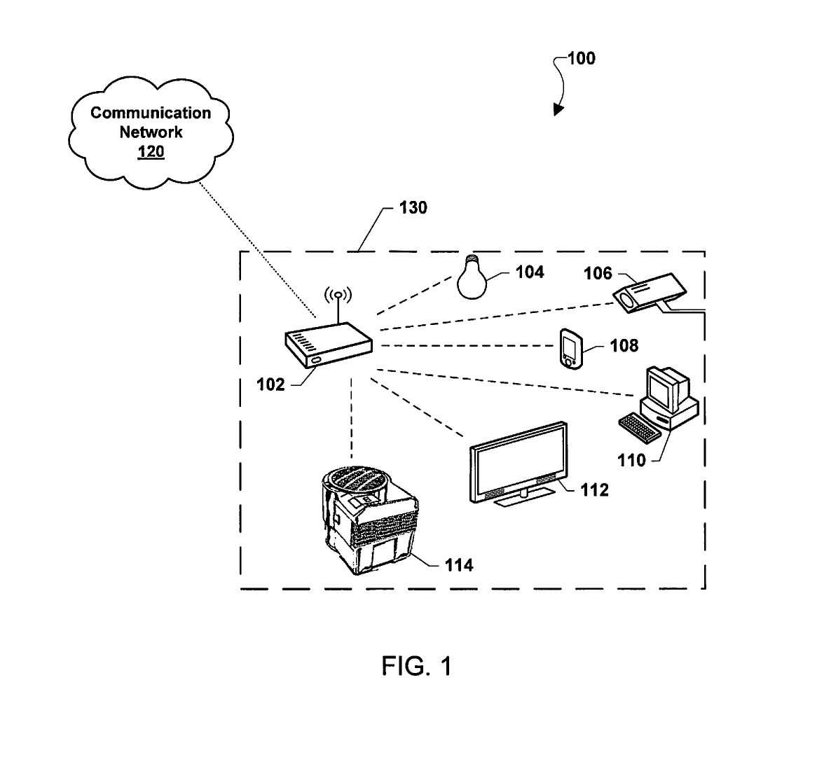

Various implementations may include one or more communication environments, an example of which is illustrated in FIG. 1. A communication environment 100 may include a router device 102 and a plurality of IoT devices 104-114.

The router device 102 may communicate via an internal communication interface with the plurality of IoT devices 104-114 by one or more wireless communication links (illustrated with dashed lines). The router device 102 also may communicate via an external communication interface with a communication network 120 by a wired or wireless communication link (illustrated with a dotted line). In some implementations, the router device 120 may include a wireless access point, such as a Wi-Fi access point.

The router device 102 may function as a network hub of an IoT network 130. The router device 102 also may function as a gateway between the IoT network 130 and the communication network 120.

Each of IoT devices 104-114 may communicate with the router device 102 using radio frequency (RF) communications. Each of the IoT devices 104-114 may function to provide communications to a device such as, for example, an IoT lighting system 104, and IoT security system 106, a mobile communication device 108, a computing device 110, a smart television 112, and an HVAC (heating, ventilation, and air conditioning) system 114. The IoT network 130 may include other examples of IoT devices without limitation.

The wireless communication links between the router device 102 and the IoT devices 104-114 may include a plurality of carrier signals, frequencies, or frequency bands, each of which may include a plurality of logical channels. Each of the wireless communication links may utilize one or more radio access technologies (RATs).

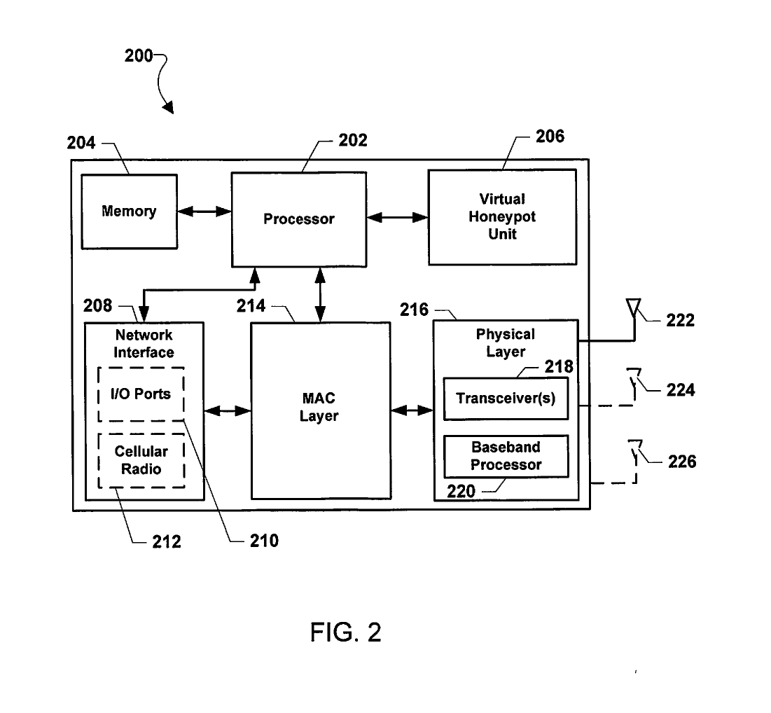

FIG. 2 is a component block diagram of an example of a router device 200 suitable for implementing various implementations. With reference to FIGS. 1 and 2, in various implementations, the router device 200 may be similar to the router device 102.

The router device 200 may include at least one controller, such as a processor 202. The processor 202 may be a processor configurable with processor-executable instructions to execute operations of various implementations, a specialized processor, such as a modem processor, configurable with processor-executable instructions to execute operations of various implementations in addition to a primary function, a dedicated hardware (i.e., “firmware”) circuit configured to perform operations of various implementations, or a combination of dedicated hardware/firmware and a programmable processor.

The processor 202 may be coupled to memory 204, which may be a non-transitory computer-readable storage medium that stores processor-executable instructions. The memory 204 may store an operating system, as well as user application software and executable instructions. The memory 204 also may store application data, such as an array data structure. The memory 204 may include one or more caches, read only memory (ROM), random access memory (RAM), electrically erasable programmable ROM (EEPROM), static RAM (SRAM), dynamic RAM (DRAM), or other types of memory. The processor 202 may read and write information to and from the memory 204. The memory 204 also may store instructions associated with one or more protocol stacks. A protocol stack generally includes processor-executable instructions to enable communication using a radio access protocol or communication protocol.

The processor 202 also may be coupled to an isolation and mitigation unit 206. In some implementations, the isolation and mitigation unit 206 may be embodied in software, firmware, hardware, or some combination of software, firmware, and hardware. In some implementations, the isolation and mitigation unit 206 may be configured to provide one or more emulated services. The processor 202 may expose an emulated service purporting to be, for example, an IoT device on the IoT network, or a legitimate network service on the IoT network. In some implementations, the processor 202 may expose the emulated service via an external communication interface outside of an IoT network (such as the IoT network 130), via an internal communication interface within or to the IoT network, or via both the internal and external communication interfaces

The isolation and mitigation unit 206 also may be configured to provide responses and behaviors (or mimic responses or behaviors) that emulate one or more vulnerabilities of an IoT device or network service that the IoT worm may attempt to exploit. The isolation and mitigation unit 206 also may be configured to execute an IoT worm or a malicious software payload of an IoT worm in a secure computing environment, such as a virtual sandbox or an isolated virtual machine, which is isolated from the operating environment of the router device.

The isolation and mitigation unit 206 also may be configured to monitor activity of an IoT worm to detect, for example, an attempt to establish communication (such as telnet) with an external IoT worm command and control server, an attempt to download additional software (such as a malicious payload), or other IoT worm activity. In some implementations, the isolation and mitigation unit 206 may record any external communication attempts by the IoT worm including any network addresses used by the IoT worm as well as other information related to the external communication attempts (such as a source address, a rate of attempted connection, a requested domain name service (DNS), etc.). In some implementations, the isolation and mitigation unit 206 may include an analytical engine for modeling, analysis, and extrapolation of attack patterns.

The isolation and mitigation unit 206 may be configured to loopback communications of the IoT worm. For example, the isolation and mitigation unit 206 may route outgoing traffic from the IoT worm (such as command and control traffic) to one or more IP addresses of the router device, thereby routing the outgoing traffic from the IoT worm to a loopback within the router device, thereby preventing propagation of the IoT worm. In such implementations, the isolation and mitigation unit 206 may provide behavior or responses to the IoT worm to emulate (falsely) that the IoT worm is successfully replicating. The isolation and mitigation unit 206 may thereby contain any infection by the IoT worm while defeating algorithms that might be included in an IoT worm to recognize an isolation and mitigation unit based little or no replication.

In some implementations, the router device 200 also may include a network interface 208 for connecting to a communication network (such as the communication network 120). In some implementations, the network interface 208 may function as an external communication interface. The router device 200 may provide various computing devices (such as the IoT devices 104-114) with access the communication network. The network interface 208 may include one or more input/output (I/O) ports 210 through which a connection to a network may be provided. For example, the I/O ports 210 may include an Ethernet connection, a fiber optic connection, a broadband cable connection, a telephone line connection, or other types of wired communication connections. Alternatively or in addition to the I/O ports 210, the network interface 208 may include a cellular radio unit 212 that provides a connection to a mobile telephony system or cellular data network through which access to the communication network may be acquired.

The processor 202 may be coupled to the Machine Access Control (MAC) layer 214. The MAC layer 214 may provide addressing and channel access control mechanisms between the network interface 208 and one or more devices associated with the router device 200, such as IoT devices and wireless communication devices. The MAC layer 214 may be connected to a physical layer 216, which may perform various encoding, signaling, and data transmission and reception functions. The physical layer 216 may include one or more transceivers 218 and a baseband processor 220 for carrying out the various functions of the physical layer 216. The physical layer 216 may be coupled to one or more wireless antennas (such as wireless antennas 222, 224, and 226) to support wireless communications with devices associated with the router device 200, such as wireless client devices or range extenders. Each of the transceivers 218 may be configured to provide communications using one or more frequency bands. The number of wireless antennas in the router device 200 is not limited to three as illustrated in FIG. 2, but may include any number of antennas. In some implementations, the physical layer 216, transceiver(s) 218, baseband processor 220, and wireless antenna(s) may function as an internal communication interface, such as within or for an IoT network (for example, the IoT network 130)

The router device 200 also may include a bus for connecting the various components of the router device 200 together, as well as hardware or software interfaces to enable communication among the various components. The router device 200 also may include various other components not illustrated in FIG. 2. For example, the router device 200 may include a number of input, output, and processing components such as buttons, lights, switches, antennas, display screen or touchscreen, various connection ports, additional processors or integrated circuits, and many other components.

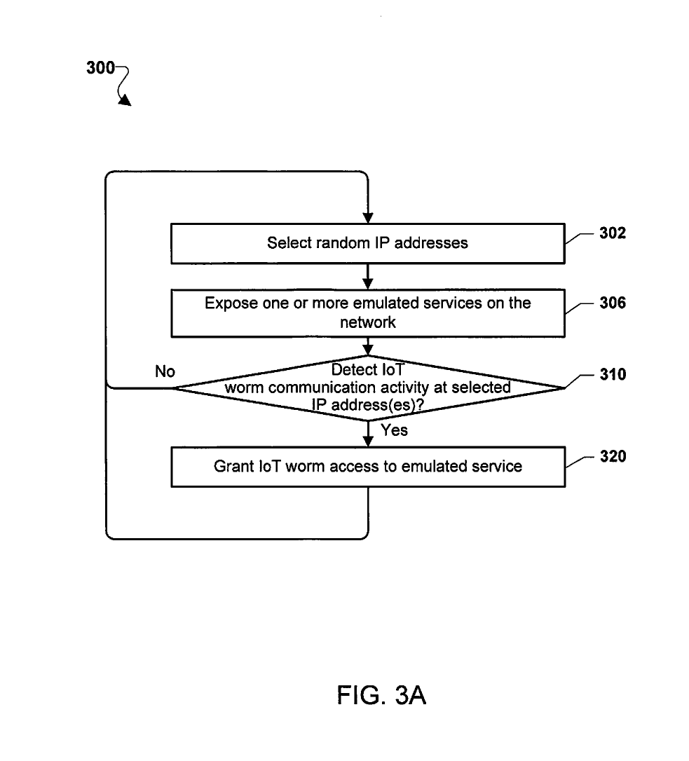

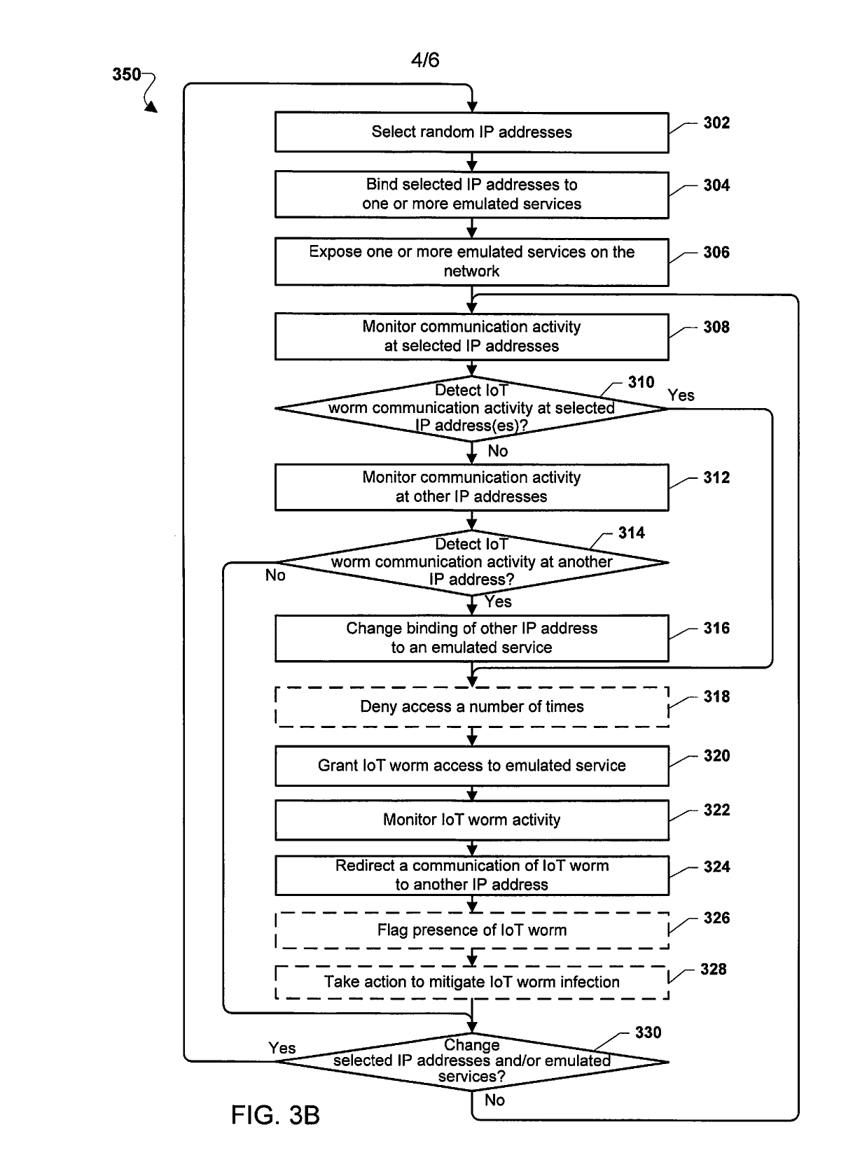

FIG. 3A is a process flow diagram illustrating a method 300 for detecting and isolating an IoT worm according to some implementations. With reference to FIGS. 1-3A, the method 300 may be implemented by a processor (such as the processor 202 or another similar processor) of a router device (such as the router devices 102 and 200).

In overview, in block 302, the processor of the router device (a “device processor”) may randomly select a plurality of IP addresses to use for emulated services. In some implementations, the router device may randomly select a range of IP addresses.

In block 306, the device processor may expose the one or more emulated services. Exposing the one or emulated services may include making available the one or more emulated services to any communication attempts, for example, by an IoT worm.

In determination block 310, the device processor may determine whether the device processor detects IoT worm communication activity at one or more of the selected IP addresses.

In response to determining that no IoT worm communication activity is detected (i.e., determination block 310=“No”), the device processor may again randomly select a plurality of IP addresses to use for emulated services in block 302.

In response to determining that IoT worm communication activity is detected (i.e., determination block 310=“Yes”), the device processor may grant or otherwise enable the IoT worm access to the emulated service in block 320.

The operations of blocks 302, 306, 310, and 320 are further described below.

FIG. 3B is a process flow diagram illustrating a method 350 for detecting and isolating an IoT worm according to some implementations. With reference to FIGS. 1-3B, the method 350 may be implemented by a processor (such as the processor 202 or another similar processor) of a router device (such as the router devices 102 and 200).

In block 302, the processor of the router device (a “device processor”) may randomly select a plurality of IP addresses to use for emulated services. Typically, the router device has access to or control over the assignment of IP addresses and data routing, and thus may control communication between an IoT worm, potential targets of the IoT worm (such as an IoT device on the IoT network), and an isolation and mitigation unit. In some implementations, the processor may select random IP addresses within a range of available IP addresses. In some implementations, the processor may randomly select the range of IP addresses.

In block 304, the device processor may bind the randomly selected plurality of IP addresses to one or more emulated services. In some implementations, the processor may bind the randomly selected IP addresses to one or more ports associated with one or more emulated services. The emulated service includes a service or device that is not actually available, and which may provide responses and other behaviors that emulate one or more vulnerabilities of an IoT device or network service that an IoT worm may attempt to exploit.

In block 306, the device processor may expose the one or more emulated services. Exposing the one or emulated services may include making available the one or more emulated services to a communication or access attempt, for example, by an IoT worm.

In block 308, the device processor may monitor communication activity at the selected IP addresses.

In determination block 310, the device processor may determine whether the device processor detects IoT worm communication activity at one or more of the selected IP addresses. For example, the device processor may determine that an attempted attack by an IoT worm is occurring by detecting a scan of a range of IP addresses (such as a telnet scan) within the selected IP addresses, multiple attempts to login to an exposed emulated service or device (such as a dictionary attack or other similar multiple login attempts), and other activity that may be typical of an IoT worm. In some implementations, the device processor may detect the IoT worm communication activity at an external communication interface of the router device, such as from an IoT worm attack originating from outside an IoT network (for example, the IoT network 130). In some implementations, the device processor may detect the IoT worm communication activity at an internal communication interface of the router device, such as from an IoT worm attack originating from within an IoT network (for example, from an IoT device in the IoT network). In some implementations, the processor may detect the IoT worm communication activity based on a communication pattern of the IoT worm. For example, the processor may detect a scan of a range of IP addresses (such as a telnet scan), multiple attempts to login to an exposed service or device (such as a dictionary attack or other similar multiple login attempts), a scan of one or more open sockets on an access point of the network, or an attempt to determine a password to access a network service or device (for example, a dictionary attack used in a sequence of access attempts).

In response to determining that no IoT worm communication activity is occurring (i.e., determination block 310=“No”), the device processor may monitor communication activity at other IP addresses in block 312. For example, the router device may monitor communication activity at one or more other IP addresses that are assigned to, for example, an IoT device or a network service.

In determination block 314, the device processor may determine whether the device processor detects IoT worm communication activity at another IP address.

In response to determining that the device processor detects IoT worm communication activity at another IP address (i.e., determination block 314=“Yes”), the device processor may change the binding of that IP address to an emulated service in block 316. For example, in response to detecting IoT worm communication activity at an IP address that is bound to an actual IoT device on the IoT network, the router device may intervene and change the binding of that IP address from the IoT device to an emulated service. This action may protect the IoT device while redirecting the IoT worm to an emulated service where activities of the IoT worm can be monitored and stimulated without propagation as described below.

In response to determining that the device processor detects IoT worm communication activity at the selected IP addresses (i.e., determination block 310=“Yes”) or after changing the binding of the other IP address to an emulated service in block 316, in optional block 318 the device processor may deny network access for a number of attempts. Denying access to the network a number of times in response to various passwords simulates the expected behavior of an actual address under a dictionary attack, and thus helps to defeat algorithms that may be implemented in an IoT worm to detect isolation and mitigation units. The number of denied attempts by the IoT worm may be varied randomly to further defeat worm algorithms designed to detect an isolation and mitigation unit. The access ultimately provided to the IoT worm may be in a manner consistent with actual addresses on the network. In some implementations, enabling the IoT worm access to the emulated service may include providing responses and behaviors (or mimicking responses or behaviors) that emulate one or more vulnerabilities of an IoT device or network service that the IoT worm may attempt to exploit. In some implementations, the device processor may permit the IoT worm to download a malicious payload after access to the emulated service is provided in optional block 318. The malicious payload may include software that, if executed without safeguards, may attempt to take control of one or more IoT devices on the IoT network or one or more functions of the router device, to perform an activity such as sending email spam or bitcoin mining, or another undesired activity. In some implementations, the device processor may permit the malicious payload to execute in a virtual sandbox environment (such as an isolated virtual machine) that is isolated from the operating environment of the router device. In block 320, the device processor may grant or otherwise enable the IoT worm access to the emulated service.

In block 322, the device processor may monitor activity of the IoT worm. In some implementations, the device processor may monitor activity of the IoT worm as the IoT worm interacts with the emulated service. For example, the emulated service may include an emulated function of the router device, or of an IoT device, which the IoT worm may attempt to exploit. In some implementations, the device processor may monitor activity of the IoT worm following its interaction with the emulated service. For example, the emulated service may include an emulated weakness in the login process, or an authentication process, which the IoT worm may attempt to exploit in order to gain access to a function of the router device or of an IoT device. In some implementations, the device processor may monitor the IoT worm activity to detect an attempt to establish communication (such as telnet) with an external IoT worm command and control server, an attempt to download additional software (such as a malicious payload), or another IoT worm activity. In some implementations, the device processor may record any external communication attempts by the IoT worm including any network addresses used by the IoT worm as well as other information related to the external communication attempts (such as a source address, a rate of attempted connection, a requested domain name service (DNS), etc.). In some implementations, the device processor may communicate the recorded information to an analytical engine for modeling, analysis, and extrapolation of attack patterns.

In block 324, the device processor may redirect a communication of the IoT worm to another IP address of the router device. A typical IoT worm may attempt to replicate itself or otherwise distribute copies of its software code. In some implementations, the device processor may redirect or loop back outward communication attempts of the IoT worm to an IP address of the router device to isolate the IoT worm and prevent the IoT worm from propagating outside of the router device. In some implementations, the router device may route outgoing traffic from the IoT worm (such as command and control traffic) to one or more IP addresses of the router device, thereby routing the outgoing traffic from the IoT worm to a loopback within the router device. In such implementations, the device processor may provide behavior or responses to the IoT worm to emulate (falsely) that the IoT worm is successfully replicating. The device processor may thereby contain any infection by the IoT worm by redirecting the communications of the IoT worm.

In optional block 326, the device processor may flag the presence of the IoT worm to another computing device or a network monitor. For example, the device processor may store an indication of the presence of the IoT worm in memory, or report the presence of the IoT worm to a user. As another example, the device processor may send a message (such as a notification or an alert message) to another device of the owner or manager of the router device (or to an owner or manager of the IoT network). As another example, the device processor may send a message to a device, system, or network of a manufacturer of the router device. In some implementations, the device processor may perform any of the foregoing in any combination.

In optional block 328, the device processor may perform an action to mitigate infection by the IoT worm. In some implementations, the device processor may perform the action to mitigate the IoT worm infection in addition to looping back attempted communications of the IoT worm. In some implementations, the device processor may take one or more actions to mitigate or isolate IoT devices on the IoT network to protect the IoT devices from the IoT worm. In some implementations, the device processor may instruct an IoT device on the IoT network to take a protective action, such as reducing or ceasing network communication, initiating an anti-IoT worm procedure, scrutinizing network traffic or communication attempts, monitoring IoT device behavior, or another remedial or protective action.

In response to determining that the device processor does not detect IoT worm communication activity at another IP address (i.e., determination block 314=“No”) or after taking an action in response to the IoT work in any of blocks 322-328, the device processor may determine whether to change the selected IP addresses or emulated services in determination block 330. For example, the device processor may periodically change the randomly selected IP addresses or the emulated services exposed, to increase the likelihood of detecting an IoT worm.

In response to determining not to change the selected IP addresses or emulated services (i.e., determination block 330=“No”), the device processor may return to monitor communication activity of the selected IP addresses in block 308.

In response to determining to change the selected IP addresses or emulated services (i.e., determination block 330=“Yes”), the device processor may random IP addresses in block 302 and continue executing the method 350 as described.

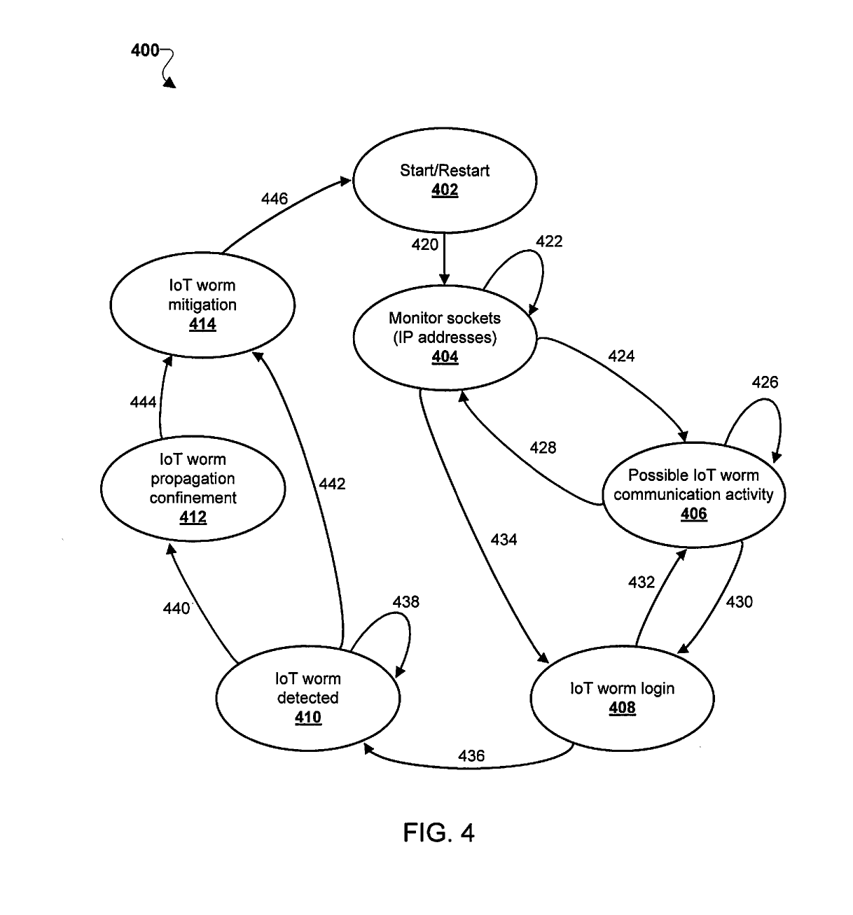

FIG. 4 is a state diagram illustrating a method 400 for detecting and isolating an IoT worm according to some implementations. With reference to FIGS. 1-4, the method 400 may be implemented by a processor (such as the processor 202 or another similar processor) of a router device (such as the router devices 102 and 200).

In the start/reset state 402, the processor may initialize one or more emulated services. For example, the processor may initialize one or more virtualized shells each accessible via a socket (for example, such as a chroot login, or a container). In some implementations, the processor may select random IP addresses within a range of available IP addresses. In some implementations, the router device may randomly select the range of IP addresses. In some implementations, the processor may bind the randomly selected plurality of IP addresses to one or more emulated services. In some implementations, the router device may bind the randomly selected IP addresses to one or more ports associated with one or more emulated services.

In some implementations, the processor may initialize one or more virtualized shells accessible by socket ports. Examples of such socket ports may include port 23 (typically associated with a telnet service), ports 20 or 21 (typically associated with a file transfer protocol (FTP) service), or port 22 (typically associated with a Secure Shell (SSH) service). The processor may choose one or more random IP addresses from among available IP addresses in a subnet of the router device. The processor may maintain a data structure that identifies IP addresses temporarily assigned to IoT devices and/or other devices in the IoT network, and the processor may select from among unassigned IP addresses. In some implementations, the processor may maintain another data structure that identifies unallocated IP addresses. For example, the data structure may include a sorted indexed list of unallocated IP addresses (which may, for example, be represented as “ip_isolation_unit_list[100]”, which indicates a list of 100 elements associated with available IP addresses).

In some implementations, to select a random subset of the unallocated IP addresses, the processor may configure a number of IP addresses to dedicate to an isolation and mitigation unit function. For example, assuming for simplicity that ten (10) IP addresses are available, the processor may select a consecutive range of IP addresses starting from a given (or randomly picked) address. In such implementations, the processor may randomly select an index I that may have a value of between 0 and 99. The processor may then select all the addresses from index ip_isolation_unit[I] to ip_isolation_unit[I+10] for allocation to the isolation and mitigation unit.

As another example, again assuming ten (10) available IP addresses, the processor may randomly select IP addresses within a range [0, 99]. The processor may assign indexes i1, i2, . . . i10 for an isolation and mitigation unit list, such as ip_isolation_unit_list[i1] . . . ip_isolation_unit_list[i10] corresponding to IP addresses allocated to the isolation and mitigation unit.

The processor may update the ip_isolation_unit_list[ ] at any time a new IoT device joins the IoT network.

In operation 420, the processor may proceed to state 404, and may monitor communication activity at the socket of each virtualized shell (for example, at one or more IP addresses). In response to determining that the processor detects no connection attempts or other communication activity, in operation 422 the processor may continue to monitor for any communication activity. In response to determining that the processor detects one or more login attempts at the one or more random sockets/IP addresses, the processor may proceed to state 408 in operation 434, as further described below.

While monitoring the socket/IP addresses in the state 404, the processor may detect communication activity at one or more sockets/IP addresses. For example, the processor may detect one or more connection attempts on one or more of the sockets/IP addresses assigned to the isolation and mitigation unit. In response to determining that the processor detects connection attempts at multiple virtual and/or real sockets, in operation 424 the processor may proceed to state 406.

The state 406 is a warning state or state of alert indicating that the processor has detected, for example, a potential IoT worm port scan. In operation 426, the processor may monitor the virtual and/or real sockets for login attempts or other attempts to access a service or device on the IoT network.

In response to determining that the processor detects no login attempts at random sockets/IP addresses (for example, for threshold period of time), in operation 428 the processor may return to the state 404 and continue to monitor the sockets/IP addresses for communication activity.

In response to determining that the processor detects one or more login attempts at the one or more random sockets/IP addresses, the processor may proceed to state 408 in operation 430. The state 408 is a state of alert in which the processor may monitor the virtual and/or real sockets for a successful login or successful access of a service or device by the suspected IoT worm. In response to determining that the processor detects no successful logins or accesses at the one or more random sockets/IP addresses, the processor may return to the state 406 in operation 432.

In response to determining that the processor detects one or more successful logins on the random sockets/IP addresses, the processor may proceed to state 410 in operation 436. In the state 410, the processor has determined that an IoT worm has been detected. In the state 410, the processor may monitor IoT worm activity. For example, in operation 438, the processor may monitor IoT worm communication activity, such as attempts at outbound communication (for example, an attempt to send a message such as the data burst, an email, Internet Relay Chat, or another form of text or binary communication). The processor may also monitor attempts by the IoT worm to propagate itself, such as by a making copies of itself and or attempting to transmit code, commands, or other information. In some implementations, the processor may monitor the IoT worm activity for port scanning for other attempts to initiate outbound communications. For example, the processor may detect and attempt to scan the internal network by the IoT worm by, for example, sending packets from the emulated service to one or more devices or other services in the network.

In response to determining that the processor detects no attempts by the IoT worm to propagate itself (such as for a threshold period of time), the processor may proceed to state 414 in operation 442. State 414 is further described below.

In response to determining that the IoT worm is attempting to propagate itself, the processor may proceed to state 412 in operation 440. In state 412, the processor may perform one or more operations to confine and prevent propagation of the IoT worm.

In some implementations, the processor may establish one or more dedicated outbound traffic queues for an emulated service. For example, the processor may allocate a dedicated outbound traffic queue for Internet Relay Chat traffic that may be used by the command and control server. As another example, the processor may allocate a dedicated outbound traffic queue for packets sent by the IoT worm that are addressed to a device or service in the IoT network. In some implementations, the processor may delay packets from the IoT worm address to a device or service in the IoT network. During a delay time period, the processor may establish one or more new emulated services and associated IP addresses in which to confine or prevent propagation of the IoT worm.

The processor may monitor the IoT worm propagation attempts or progress to determine whether the IoT worm is confined within one or more emulated services. In some implementations, determining that the IoT worm is confined may include detecting that the IoT worm has engaged in an Internet Relay Chat (IRC) (such as sending one or more IRC messages) for a threshold period of time. In some implementations, the processor may notify an administrator or owner of the IoT network of the detected presence of the IoT worm, or of one or more confinement or mitigation operations performed by the processor.

In response to determining that the IoT worm is confined, the processor may proceed to state 414 in operation 444. In the state 414, the processor may perform one or more operations related to mitigating the network vulnerability or vulnerabilities that the IoT worm used successfully to access the IoT network. For example, the processor may apply a system patch, code patch, software correction, implement a change in a procedure or call, or perform another corrective action at a system level, to reduce the network vulnerability used by the IoT worm.

In response to determining that the processor has completed the one or more operations related to mitigating the network vulnerability, the processor may proceed to the state 402 in operation 446.

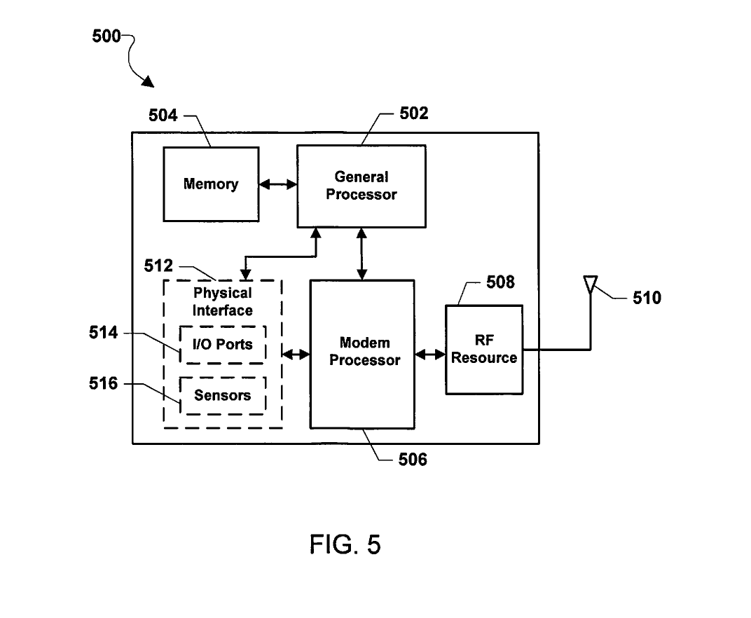

Various implementations may include any of a variety of IoT devices, an example of which is illustrated in FIG. 5. With reference to FIGS. 1-5, in various implementations, an IoT device 500 may be similar to the IoT devices 104-114.

The IoT device 500 may include at least one processor, such as a general processor 502, which may be coupled to at least one memory 504. The memory 504 may be a non-transitory computer-readable storage medium that stores processor-executable instructions. The memory 504 may store an operating system, user application software, or other executable instructions. The memory 504 also may store application data, such as an array data structure. The memory 504 may include one or more caches, read only memory (ROM), random access memory (RAM), electrically erasable programmable ROM (EEPROM), static RAM (SRAM), dynamic RAM (DRAM), or other types of memory. The general processor 502 may read and write information to and from the memory 504. The memory 504 also may store instructions associated with one or more protocol stacks. A protocol stack generally includes computer executable instructions to enable communication using a radio access protocol or communication protocol.

The processor 502 and the memory 504 may communicate with at least one modem processor 506. The modem processor 506 may perform modem functions for communications with one or more other IoT devices, access points, base stations, and other such devices. The modem processor 506 may be coupled to an RF resource 508. The RF resource 508 may include various circuitry and components to enable the sending, receiving, and processing of radio signals, such as a modulator/demodulator component, a power amplifier, a gain stage, a digital signal processor (DSP), a signal amplifier, a filter, and other such components. The RF resource 508 may be coupled to a wireless antenna (such as a wireless antenna 510). The IoT device 500 may include additional RF resources or antennas without limitation. The RF resource 508 may be configured to provide communications using one or more frequency bands via the antenna 510.

In some implementations, the processor 502 also may communicate with a physical interface 512 configured to enable a wired connection to another device. The physical interface 512 may include one or more input/output (110) ports 514 configured to enable communications with the device to which the IoT device is connected. The physical interface 512 also may include one or more sensors 516 to enable the IoT device to detect information about a device with which the IoT device 500 is connected via the physical interface 512. Examples of devices with which the IoT device may be connected include smart appliances including televisions, set top boxes, kitchen appliances, lights and lighting systems, smart electricity meters, air conditioning/HVAC systems, thermostats, building security systems, doors and windows, door and window locks, building diagnostic and monitoring systems, and other devices.

The IoT device 500 also may include a bus for connecting the various components of the IoT device 200 together, as well as hardware or software interfaces to enable communication among the various components. The IoT device 500 also may include various other components not illustrated in FIG. 5. For example, the IoT device 500 may include a number of input, output, and processing components, such as buttons, lights, switches, antennas, display screen or touchscreen, various connection ports, additional processors or integrated circuits, and many other components.

Various implementations illustrated and described are provided merely as examples to illustrate various features of the claims. However, features shown and described with respect to any given implementation are not necessarily limited to the associated implementation and may be used or combined with other implementations that are shown and described. Further, the claims are not intended to be limited by any one example implementation.

The foregoing method descriptions and the process flow diagrams are provided merely as illustrative examples and are not intended to require or imply that the blocks of various implementations must be performed in the order presented. As will be appreciated by one of skill in the art the order of blocks in the foregoing implementations may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the implementations disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the implementations disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the device processor may be any conventional processor, controller, microcontroller, or state machine. A processor also may be implemented as a combination of communication devices, such as a combination of a DSP and a microprocessor, a plurality of microprocessors, one or more microprocessors in conjunction with a DSP core, or any other such configuration. Alternatively, some blocks or methods may be performed by circuitry that is specific to a given function.

In various implementations, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes or instructions on a non-transitory processor-readable medium or computer-readable medium, which may be incorporated into a computer program product.

The preceding description of the disclosed implementations is provided to enable any person skilled in the art to make or use the present implementations. Various modifications to these implementations will be readily apparent to those skilled in the art, and the generic principles defined herein may be applied to other implementations without departing from the spirit or scope of the implementations. Thus, various implementations are not intended to be limited to the implementations shown herein but are to be accorded the widest scope consistent with the following claims and the principles and novel features disclosed herein.

What is claimed is:

1. A router device, comprising:
a communication interface; and
a processor coupled to the communication interface and configured with processor-executable instructions to perform operations comprising:
randomly selecting a plurality of Internet Protocol (IP) addresses;
exposing at the plurality of randomly selected IP addresses one or more emulated services;
determining whether Internet of Things (IoT) worm communication activity is detected at one of the selected IP addresses; and
enabling the IoT worm access to one of the emulated services in response to detecting the IoT worm communication activity at the one of the selected IP addresses.

2. The router device of claim 1, wherein the processor is configured with processor-executable instructions to perform operations further comprising:
binding the randomly selected plurality of IP addresses to the one or more emulated services.

3. The router device of claim 1, wherein the processor is configured with processor-executable instructions to perform operations such that detecting the IoT worm communication activity at one of the selected IP addresses is based on a communication pattern of the IoT worm.

4. The router device of claim 1, wherein the processor is configured with processor-executable instructions to perform operations further comprising:
redirecting a communication of the IoT worm to another IP address of the router device.

5. The router device of claim 1, wherein the processor is configured with processor-executable instructions to perform operations further comprising:
monitoring communication activity at the randomly selected IP addresses; and
determining whether the IoT worm communication activity is detected at one or more of the randomly selected IP addresses.

6. The router device of claim 1, wherein the processor is configured with processor-executable instructions to perform operations further comprising:
changing a binding of an IP address other than the plurality of randomly selected IP addresses in response to determining that IoT worm communication activity is detected at the other IP address.

7. The router device of claim 6, wherein the processor is configured with processor-executable instructions to perform operations further comprising:
determining whether to change one or more of the randomly selected IP addresses and the emulated services in response to determining that IoT worm communication activity is not detected at the other IP address.

8. The router device of claim 1, wherein the processor is configured with processor-executable instructions to perform operations such that enabling the IoT worm access to one of the emulated services comprises denying access to the one of the emulated services a number of times before enabling access to one of the emulated services.

9. The router device of claim 1, wherein the processor is configured with processor-executable instructions to perform operations further comprising sending a message to one or more of a device of a manager of the router device and a device of a manufacturer of the router device to flag a presence of the IoT worm.

10. The router device of claim 1, wherein the processor is configured with processor-executable instructions to perform operations further comprising:
taking an action to mitigate infection by the IoT worm.

11. A method of mitigating an Internet of Things (IoT) worm, comprising:
randomly selecting, by a router device, a plurality of Internet Protocol (IP) addresses;
advertising at the plurality of randomly selected IP addresses one or more emulated services;
determining whether IoT worm activity is detected at one of the selected IP addresses; and
providing an IoT worm access to one of the emulated services in response to detecting IoT worm communication activity at one of the selected IP addresses.

12. The method of claim 11, further comprising:
binding the randomly selected plurality of IP addresses to the one or more emulated services.

13. The method of claim 11, wherein detecting the IoT worm communication activity at one of the selected IP addresses is based on a communication pattern of the IoT worm.

14. The method of claim 11, further comprising:
redirecting a communication of the IoT worm to another IP address of the router device.

15. The method of claim 11, further comprising:
monitoring communication activity at the randomly selected IP addresses; and
determining whether the IoT worm communication activity is detected at one or more of the randomly selected IP addresses.

16. The method of claim 11, further comprising:
changing a binding of an IP address other than the plurality of randomly selected IP addresses in response to determining that IoT worm communication activity is detected at the other IP address.

17. The method of claim 16, further comprising:
determining whether to change one or more of the randomly selected IP addresses and the emulated services in response to determining that IoT worm communication activity is not detected at the other IP address.

18. The method of claim 11, wherein providing the IoT worm access to one of the emulated services comprises denying access to the one of the emulated services a number of times before providing access to one of the emulated services.

19. The method of claim 11, further comprising:
sending a message to one or more of a device of a manager of the router device and a device of a manufacturer of the router device to flag a presence of the IoT worm.

20. The method of claim 11, further comprising:
taking an action to mitigate infection by the IoT worm.

21. A router device, comprising:
means for randomly selecting, by a router device, a plurality of Internet Protocol (IP) addresses;
means for advertising at the plurality of randomly selected IP addresses one or more emulated services;
means for determining whether IoT worm activity is detected at one of the selected IP addresses; and
means for enabling an Internet of Things (IoT) worm access to one of the emulated services in response to detecting IoT worm communication activity at one of the selected IP addresses.

22. The router device of claim 21, further comprising:
means for binding the randomly selected plurality of IP addresses to the one or more emulated services.

23. The router device of claim 21, further comprising:
means for monitoring communication activity at the randomly selected IP addresses; and
means for determining whether the IoT worm communication activity is detected at one or more of the randomly selected IP addresses.

24. The router device of claim 21, further comprising:
means for changing a binding of an IP address other than the plurality of randomly selected IP addresses in response to determining that IoT worm communication activity is detected at the other IP address.

25. The router device of claim 24, further comprising:
means for determining whether to change one or more of the randomly selected IP addresses and the emulated services in response to determining that IoT worm communication activity is not detected at the other IP address.

26. A non-transitory processor-readable storage medium having stored thereon processor-executable instructions configured to cause a processor of a router device to perform operations for mitigating an Internet of Things (IoT) worm comprising:
randomly selecting a plurality of Internet Protocol (IP) addresses;
advertising at the plurality of randomly selected IP addresses one or more emulated services;
enabling an IoT worm access to one of the emulated services in response to detecting IoT worm communication activity at one of the selected IP addresses; and
redirecting a communication of the IoT worm to another IP address of the router device.

27. The non-transitory processor-readable storage medium of claim 26, wherein the stored processor-executable instructions are configured to cause the processor of the router device to perform operations further comprising:
binding the randomly selected plurality of IP addresses to the one or more emulated services.

28. The non-transitory processor-readable storage medium of claim 26, wherein the stored processor-executable instructions are configured to cause the processor of the router device to perform operations further comprising:
monitoring communication activity at the randomly selected IP addresses; and
determining whether the IoT worm communication activity is detected at one or more of the randomly selected IP addresses.

29. The non-transitory processor-readable storage medium of claim 26, wherein the stored processor-executable instructions are configured to cause the processor of the router device to perform operations further comprising:
changing a binding of an IP address other than the plurality of randomly selected IP addresses in response to determining that IoT worm communication activity is detected at the other IP address.

30. The non-transitory processor-readable storage medium of claim 29, wherein the stored processor-executable instructions are configured to cause the processor of the router device to perform operations further comprising:
determining whether to change one or more of the randomly selected IP addresses and the emulated services in response to determining that IoT worm communication activity is not detected at the other IP address.
